(19) United States
(12) Patent Application Publication
(10) Pub. No.: US 2024/0065126 A1
(43) Pub. Date: Feb. 29, 2024

(54) DISC BLADE ANGLE ADJUSTMENT ASSEMBLY FOR A TILLAGE IMPLEMENT

(71) Applicant: CNH Industrial America LLC, New Holland, PA (US)

(72) Inventors: Heath A. Toennies, Eureka, IL (US); Timothy Richard Blunier, Racine, WI (US); Sven Nathaniel Setterdahl, Maquon, IL (US); Jared Paul Schaffer, Normal, IL (US)

(21) Appl. No.: 17/900,112

(22) Filed: Aug. 31, 2022

(51) Int. Cl. A01B 35/16; A01B 63/24; A01B 63/32

(52) U.S. Cl. CPC A01B 35/16; A01B 63/245; A01B 63/32

(57) ABSTRACT

A disc blade angle adjustment assembly for a tillage implement includes a base structure configured to couple to a frame of the tillage implement. The disc blade angle adjustment assembly also includes a vertical guide plate coupled to the base structure, in which the vertical guide plate has an elongated opening. Furthermore, the disc blade angle adjustment assembly includes a vertical support configured to couple to a disc blade support of the tillage implement. The disc blade support is configured to pivotally couple to the frame at a pivot point. The disc blade angle adjustment assembly also includes multiple rollers rotatably coupled to the vertical support and disposed within the elongated opening of the vertical guide plate. The rollers are configured to block rotation of the disc blade support about a longitudinal axis of the disc blade support via engagement with the vertical guide plate.

### BACKGROUND

The present disclosure relates to a disc blade angle adjustment assembly for a tillage implement.

Certain agricultural implements include ground engaging tools configured to interact with soil. For example, a tillage implement may include disc blades configured to break up the soil for subsequent planting or seeding operations. Groups of disc blades may be arranged in gangs, and each gang of disc blades may be rotatably coupled to a frame of the tillage implement. In certain tillage implements, an angle of each gang may be adjustable relative to the frame, thereby facilitating adjustment of the angle of the disc blades of the gang relative to a direction of travel of the tillage implement. For example, the gang of disc blades may be rotatably coupled to a gang support, and the gang support may be pivotally coupled to the frame of the tillage implement. Accordingly, the angle of the disc blades of the gang relative to the direction of travel may be adjusted by rotating the gang support relative to the frame.

In certain tillage implements, a gang angle adjustment assembly is configured to control the rotational movement of the gang support. For example, the gang angle adjustment assembly may include a horizontal plate coupled to the frame of the tillage implement. The horizontal plate may include multiple apertures configured to receive a bolt, and the gang support may include a single aperture configured to receive the bolt. The bolt may extend through one of the apertures of the horizontal plate and the aperture of the gang support to block rotation of the gang support relative to the frame. To adjust the angle of the disc blades of the gang, the bolt may be unfastened (e.g., by removal of a nut) and removed from the apertures. As the bolt is unfastened, rollers coupled to the gang support may engage a top surface of the horizontal plate to support the weight of the gang support and the gang of disc blades rotatably coupled to the gang support. The gang support may then be rotated to a suitable angle while the rollers support the weight of the gang support/gang of disc blades and facilitate rotation of the gang support. The bolt may then be engaged with a selected aperture of the horizontal plate and the aperture of the gang support, and the bolt may be fastened (e.g., by engagement of the nut). As the bolt is fastened, the weight supported by the rollers is transferred to the bolt, such that the rollers are disengaged from the top surface of the horizontal plate while the bolt is fastened. In addition, fastening the bolt establishes a contact force between the gang support and the horizontal plate. Due to the flat contact surfaces of the gang support and the horizontal plate, the contact force applied by the bolt substantially blocks rotation of the gang support about the longitudinal axis of the gang support. Unfortunately, the process of unfastening the bolt, removing the bolt from the apertures, rotating the gang support to a desired orientation, engaging the bolt with the apertures, and fastening the bolt is significantly time-consuming and utilizes tools (e.g., to engage/remove the nut), thereby reducing the efficiency of the gang angle adjustment process.

### BRIEF DESCRIPTION

In certain embodiments, a disc blade angle adjustment assembly for a tillage implement includes a base structure configured to couple to a frame of the tillage implement. The disc blade angle adjustment assembly also includes a vertical guide plate coupled to the base structure, in which the vertical guide plate has an elongated opening. Furthermore, the disc blade angle adjustment assembly includes a vertical support configured to couple to a disc blade support of the tillage implement. The disc blade support is configured to pivotally couple to the frame at a pivot point, and the disc blade support is configured to support multiple disc blades. The disc blade angle adjustment assembly also includes multiple rollers rotatably coupled to the vertical support and disposed within the elongated opening of the vertical guide plate. The rollers are configured to block rotation of the disc blade support about a longitudinal axis of the disc blade support via engagement with the vertical guide plate.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a tillage implement having disc blade angle adjustment assemblies;

FIG. 2 is a perspective view of an embodiment of a disc blade angle adjustment assembly that may be employed within the tillage implement of FIG. 1;

FIG. 3 is another perspective view of the disc blade angle adjustment assembly of FIG. 2;

FIG. 4 is a further perspective view of the disc blade angle adjustment assembly of FIG. 2; and

FIG. 5 is a perspective view of another embodiment of a disc blade angle adjustment assembly that may be employed within the tillage implement of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

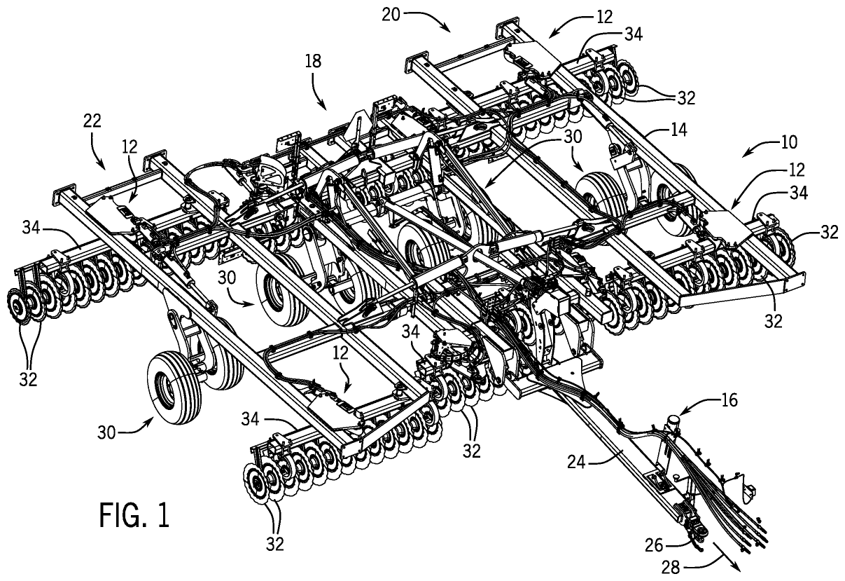

FIG. 1 is a perspective view of an embodiment of a tillage implement 10 having disc blade angle adjustment assemblies 12. In the illustrated embodiment, the tillage implement 10 is a vertical tillage implement having multiple ground engaging tools configured to till soil. As illustrated, the tillage implement 10 includes a frame 14 and a hitch assembly 16 coupled to the frame 14. In the illustrated embodiment, the frame 14 includes a center section 18, a left wing section 20, and a right wing section 22. Each wing section is configured to rotate upwardly from the illustrated working position to a transport position to facilitate transport of the tillage implement 10. For example, one or more actuators (e.g., hydraulic cylinder(s), etc.) may be configured to drive each wing section to rotate between the illustrated working position and the transport position. While the frame 14 includes the center section 18, the left wing section 20, and the right wing section 22 in the illustrated embodiment, in other embodiments, the frame may include more or fewer sections. For example, in certain embodiments, the frame may be substantially rigid (e.g., not including any translatable and/or rotatable components). Furthermore, the frame 14 may be formed from multiple frame elements (e.g., rails, tubes, braces, etc.) coupled to one another (e.g., via welded connection(s), via fastener(s), etc.).

In the illustrated embodiment, the hitch assembly 16 includes a hitch frame 24 and a hitch 26. The hitch frame 24 is pivotally coupled to the implement frame 14 via pivot joint(s), and the hitch 26 is configured to couple to a corresponding hitch of a work vehicle (e.g., tractor), which is configured to tow the tillage implement 10 through a field along a direction of travel 28. While the hitch frame 24 is pivotally coupled to the implement frame 14 in the illustrated embodiment, in other embodiments, the hitch frame may be movably coupled to the implement frame by a linkage assembly (e.g., four bar linkage assembly, etc.) or another suitable assembly/mechanism that enables the hitch to move along a vertical axis relative to the implement frame, or the hitch frame may be rigidly coupled to the implement frame.

As illustrated, the tillage implement 10 includes wheel assemblies 30 movably coupled to the implement frame 14. In the illustrated embodiment, each wheel assembly 30 includes a wheel frame and a wheel rotatably coupled to the wheel frame. The wheels of the wheel assemblies 30 are configured to engage the surface of the soil, and the wheel assemblies 30 are configured to support at least a portion of the weight of the tillage implement 10. In the illustrated embodiment, each wheel frame is pivotally coupled to the implement frame 14, thereby facilitating adjustment of the vertical position of the respective wheel(s). However, in other embodiments, at least one wheel frame may be movably coupled to the implement frame by another suitable connection (e.g., sliding connection, linkage assembly, etc.) that facilitates adjustment of the vertical position of the respective wheel(s).

In the illustrated embodiment, the tillage implement 10 includes disc blades 32 configured to engage a top layer of the soil. As the tillage implement 10 is towed through the field, the disc blades 32 are driven to rotate, thereby breaking up the top layer of the soil. In the illustrated embodiment, the disc blades 32 are arranged in two rows. However, in other embodiments, the disc blades may be arranged in more or fewer rows (e.g., 1, 3, 4, 5, 6, or more). Furthermore, in the illustrated embodiment, each row of disc blades 32 includes four gangs of disc blades 32. Two gangs of disc blades of the front row are coupled to the center section 18, two gangs of disc blades of the rear row are coupled to the center section 18, one gang of disc blades of the front row is coupled to the left wing section 20, one gang of disc blades of the rear row is coupled to the left wing section 20, one gang of disc blades of the front row is coupled to the right wing section 22, and one gang of disc blades of the rear row is coupled to the right wing section 22. While the tillage implement 10 includes eight gangs of disc blades 32 in the illustrated embodiment, in other embodiments, the tillage implement may include more or fewer gangs of disc blades (e.g., 2, 4, 6, 10, or more). Furthermore, the gangs of disc blades may be arranged in any suitable configuration on the implement frame.

The disc blades 32 of each gang are non-rotatably coupled to one another by a respective shaft, such that the disc blades 32 of each gang rotate together. Each shaft is rotatably coupled to a respective disc blade support 34, which is configured to support the gang, including the shaft and the disc blades 32. Furthermore, each disc blade support 34 is pivotally coupled to the frame 14 at a respective pivot point, thereby enabling the disc blade support 34 to rotate relative to the frame 14. Rotating the disc blade support 34 relative to the frame 14 controls the angle between the respective disc blades 32 and the direction of travel 28, thereby controlling the interaction of the disc blades 32 with the top layer of the soil. Each disc blade support 34 may include any suitable structure(s) configured to support the respective gang (e.g., including a square tube, a round tube, a bar, a truss, other suitable structure(s), or a combination thereof). While the disc blades 32 supported by each disc blade support 34 are arranged in a respective gang (e.g., non-rotatably coupled to one another by a respective shaft) in the illustrated embodiment, in other embodiments, at least a portion of the disc blades supported by at least one disc blade support (e.g., all of the disc blades supported by the disc blade support) may be arranged in another suitable configuration (e.g., individually mounted and independently rotatable, mounted in groups and individually rotatable, etc.). For example, in certain embodiments, a first portion of the disc blades supported by a disc blade support may be arranged in a gang, and a second portion of the disc blades supported by the disc blade support may be individually mounted and independently rotatable.

In the illustrated embodiment, the rotation of each gang of disc blades 32 is controlled by a respective disc blade angle adjustment assembly 12. As discussed in detail below, each disc blade angle adjustment assembly 12 includes a base structure coupled to the frame 14 of the tillage implement 10. In addition, the disc blade angle adjustment assembly 12 includes a guide structure (e.g., vertical guide plate, etc.) coupled to the base structure, and the guide structure has an elongated opening. The disc blade angle adjustment assembly 12 also includes a vertical support coupled to the respective disc blade support 34 of the tillage implement 10. As previously discussed, the disc blade support 34 is pivotally coupled to the frame 14 at the pivot point, and the disc blade support 34 is configured to support multiple disc blades 32 (e.g., a gang of disc blades 32). Furthermore, the disc blade angle adjustment assembly 12 includes multiple rollers rotatably coupled to the vertical support and disposed within the elongated opening of the guide structure. The rollers are configured to block rotation of the disc blade support about a longitudinal axis of the disc blade support via engagement (e.g., contact) with the guide structure. Accordingly, a bolt, which may be used to drive the disc blade support into contact with the base structure to block rotation of the disc blade support about the longitudinal axis of the disc blade support, is obviated. As a result, the angle of the disc blades may be adjusted without a tool (e.g., to fasten/unfasten the bolt), and the duration associated with adjusting the angle of the disc blades may be reduced, thereby increasing the efficiency of the disc blade angle adjustment process.

While the tillage implement includes the disc blades 32 in the illustrated embodiment, in other embodiments, the tillage implement may include other/additional ground engaging tool(s) (e.g., coupled to the disc blade support(s), coupled to the frame of the tillage implement, etc.). For example, in certain embodiments, the tillage implement may include tillage point assemblies (e.g., positioned behind the disc blades relative to the direction of travel) configured to engage the soil at a greater depth than the disc blades, thereby breaking up a lower layer of the soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g., positioned behind the disc blades relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), finishing reel(s), other suitable ground engaging tool(s), or a combination thereof. Furthermore, while the tillage implement 10 is a vertical tillage implement in the illustrated embodiment, in other embodiments, the tillage implement may be a primary tillage implement or another suitable type of tillage implement.

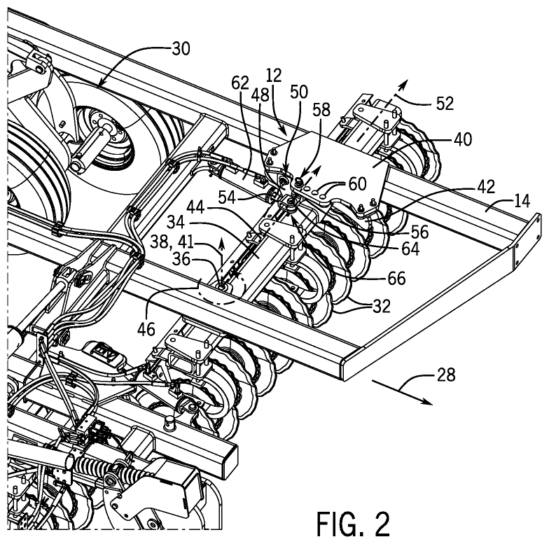

FIG. 2 is a perspective view of an embodiment of a disc blade angle adjustment assembly 12 that may be employed within the tillage implement of FIG. 1. As previously discussed, the disc blades 32 of the tillage implement 10 are supported by multiple disc blade supports 34, and each disc blade support 34 is pivotally coupled to the frame 14 at a respective pivot point 36. Each pivot point 36 may include any suitable structure(s) (e.g., shaft(s), bearing(s), bushing(s), etc.) configured to couple the respective disc blade support 34 to the frame and to enable the disc blade support 34 to pivot about a pivot axis 38 relative to the frame 14. Furthermore, as previously discussed, rotating the disc blade support 34 relative to the frame 14 controls the angle between the respective disc blades 32 and the direction of travel 28, thereby controlling the interaction of the disc blades 32 with the top layer of the soil.

In the illustrated embodiment, the disc blade angle adjustment assembly 12 includes a horizontal base plate 40 (e.g., base structure) coupled to the frame 14. In the illustrated embodiment, the horizontal base plate 40 is coupled to the frame by a welded connection. However, in other embodiments, the horizontal base plate may be coupled to the frame by other suitable type(s) of connection(s) (e.g., alone or in combination with the welded connection), such as a fastener connection, an adhesive connection, a clamped connection, other suitable type(s) of connection(s), or a combination thereof. Furthermore, in certain embodiments, the horizontal base plate may be integrally formed with the frame. In addition, while the horizontal base plate 40 is coupled to a single tube of the frame 14 in the illustrated embodiment, in other embodiments, the horizontal base plate may be coupled to other and/or additional element(s) of the frame. In addition, while the horizontal base plate 40 is directly coupled to the frame 14 in the illustrated embodiment, in other embodiments, the horizontal base plate may be indirectly coupled to the frame via one or more other suitable elements. As used herein with regard to the horizontal base plate 40, “plate” refers to a structure having a thickness (e.g., vertical extent, extent along a vertical axis 41) that is less than a length (e.g., horizontal extent) and less than a width (e.g., horizontal extent) of the structure.

In the illustrated embodiment, the disc blade angle adjustment assembly 12 includes a vertical guide plate 42 (e.g., guide structure) coupled to the horizontal base plate 40. As discussed in detail below, the vertical guide plate 42 has an elongated opening configured to receive rollers. As used herein with regard to the vertical guide plate 42, “plate” refers to a structure having a thickness (e.g., radial extent, extent along a radial axis 44) that is less than a length (e.g., circumferential extent, extent along a circumferential axis 46) and less than a width (e.g., vertical extent, extent along a vertical axis 41) of the structure. In the illustrated embodiment, the elongated opening extends through the vertical guide plate 42 in a direction along the thickness of the vertical guide plate 42 (e.g., between an outer radial side of the vertical guide plate and an inner radial side of the vertical guide plate). In addition, in the illustrated embodiment, the radial axis 44 and the circumferential axis 46 have an origin at the pivot point 36/pivot axis 38.

Furthermore, in the illustrated embodiment, the disc blade angle adjustment assembly 12 includes a vertical support 48 coupled to the disc blade support 34. In the illustrated embodiment, the vertical support 48 is coupled to the disc blade support 34 by a welded connection. However, in other embodiments, the vertical support may be coupled to the disc blade support by other suitable type(s) of connection(s) (e.g., alone or in combination with the welded connection), such as a fastener connection, an adhesive connection, a clamped connection, other suitable type(s) of connection(s), or a combination thereof. Furthermore, in certain embodiments, the vertical support may be integrally formed with the disc blade support. In addition, in the illustrated embodiment, the vertical support 48 is shaped as a vertical plate. However, in other embodiments, the vertical support may have another suitable shape.

In the illustrated embodiment, the disc blade angle adjustment assembly 12 includes rollers 50 rotatably coupled to the vertical support 48 and disposed within the elongated opening of the vertical guide plate 42. The rollers are configured to block rotation of the disc blade support 34 about a longitudinal axis 52 of the disc blade support 34 via engagement (e.g., contact) with the vertical guide plate 42. Accordingly, a bolt, which may be used to drive the disc blade support into contact with the horizontal base plate to block rotation of the disc blade support about the longitudinal axis of the disc blade support, is obviated. As a result, the angle of the disc blades may be adjusted without a tool (e.g., to fasten/unfasten the bolt), and the duration associated with adjusting the angle of the disc blades may be reduced, thereby increasing the efficiency of the disc blade angle adjustment process. In the illustrated embodiment, the disc blade angle adjustment assembly 12 includes two rollers 50. However, in other embodiments, the disc blade angle adjustment assembly may include additional rollers (e.g., 1, 2, 3, 4 or more additional rollers) rotatably coupled to the vertical support and disposed within the elongated opening of the vertical guide plate. Furthermore, in the illustrated embodiment, each roller 50 is only coupled to the vertical support 48, thereby reducing the cost and complexity of the disc blade angle adjustment assembly 12 (e.g., as compared to a disc blade angle adjustment assembly having a strap/support extending between rollers to provide additional support to the rollers). While each roller is only coupled to the vertical support in the illustrated embodiment, in other embodiments, at least one roller may be coupled to the vertical support and another suitable structure/element (e.g., structure/element of the disc blade angle adjustment assembly).

In the illustrated embodiment, the vertical guide plate 42 has an arcuate shape with a radius of curvature extending from the pivot point 36/pivot axis 38. Accordingly, the elongated opening within the vertical guide plate 42 extends along the circumferential axis 46. Furthermore, in the illustrated embodiment, the rotational axis 54 of each roller 50 is aligned with the radial axis 44/extends toward the pivot point 36/pivot axis 38. As a result, the rollers 50 may be aligned with the vertical guide plate 42 along the radial axis 44 at the elongated opening throughout the range of motion of the rollers 50 within the elongated opening. While the vertical guide plate 42 has an arcuate shape and the rotational axis 54 of each roller 50 extends toward the pivot point 36/pivot axis 38 in the illustrated embodiment, in other embodiments, the vertical guide plate may have another suitable shape (e.g., linear, etc.), and/or the rotational axis of at least one roller may extend toward another suitable point (e.g., the rotational axes of at least two rollers may be parallel to one another). In such embodiments, the thickness (e.g., radial extent) of the vertical guide plate and/or the width (e.g., radial extent) of the rollers may be selected such that the rollers overlap the vertical guide plate along the radial axis at the elongated opening throughout the range of motion of the rollers within the elongated opening. Furthermore, while the disc blade angle adjustment assembly 12 includes the vertical guide plate 42 in the illustrated embodiment, in other embodiments (e.g., in embodiments in which the rotational axis of at least one roller does not extend toward the pivot point 36/pivot axis 38), the disc blade angle adjustment assembly may include another suitable guide structure having the elongated opening.

In the illustrated embodiment, the disc blade angle adjustment assembly 12 includes a horizontal protrusion 56 coupled to the vertical support 48. As discussed in detail below, the horizontal protrusion 56 has a first pin aperture configured to receive a pin 58 of the disc blade angle adjustment assembly 12. In addition, the horizontal base plate 40 has multiple second pin apertures 60 configured to receive the pin 58. The pin 58 is configured to engage the first pin aperture of the horizontal protrusion 56 and a selected pin aperture of the second pin apertures 60 of the horizontal base plate 40 to block rotation of the disc blade support 34 about the pivot point 36/pivot axis 38. In the illustrated embodiment, the horizontal protrusion 56 is coupled to the vertical support 48 by a welded connection. However, in other embodiments, the horizontal protrusion may be coupled to the vertical support by other suitable type(s) of connection(s) (e.g., alone or in combination with the welded connection), such as a fastener connection, an adhesive connection, a clamped connection, other suitable type(s) of connection(s), or a combination thereof. Furthermore, in certain embodiments, the horizontal protrusion may be integrally formed with the vertical support.

To adjust the angle of the disc blades 32 relative to the direction of travel 28, the pin 58 may be removed from the first pin aperture of the horizontal protrusion 56 and the second pin aperture 60 of the horizontal base plate 40. The disc blade support 34 may then be rotated to a desired angle. The pin 58 may then be inserted through the first pin aperture and a selected second pin aperture 60, thereby blocking rotation of the disc blade support 34 about the pivot point 36/pivot axis 38. Because the rollers 50 block rotation of the disc blade support 34 about the longitudinal axis 52 via engagement (e.g., contact) with the vertical guide plate 42, a bolt, which may be used to drive the disc blade support into contact with the horizontal base plate to block rotation of the disc blade support about the longitudinal axis of the disc blade support, is obviated. As a result, the angle of the disc blades may be adjusted without a tool (e.g., to fasten/unfasten the bolt), and the duration associated with adjusting the angle of the disc blades may be reduced, thereby increasing the efficiency of the disc blade angle adjustment process.

In the illustrated embodiment, the disc blade angle adjustment assembly 12 includes an actuator 62 coupled to the vertical support 48 and to the frame 14 of the tillage implement. The actuator 62 is configured to drive the disc blade support 34 to rotate about the pivot point 36/pivot axis 38, thereby controlling the angle of the disc blades 32 relative to the direction of travel 28. In the illustrated embodiment, the actuator 62 includes a hydraulic cylinder. However, in other embodiments, the actuator may include another suitable type of actuating device (e.g., alone or in combination with the hydraulic cylinder), such as a pneumatic cylinder, a hydraulic motor, a pneumatic motor, an electric motor, an electric linear actuator, other suitable type(s) of actuating device(s), or a combination thereof.

In the illustrated embodiment, the actuator 62 includes a fastener 64, and the horizontal protrusion 56 has a fastener aperture 66. As illustrated, the fastener 64 of the actuator 62 is engaged with the fastener aperture 66 of the horizontal protrusion 56. While the actuator 62 is coupled to the vertical support 48 via the horizontal protrusion 56 in the illustrated embodiment, in other embodiments, the actuator may be directly coupled to the vertical support, or the actuator may be coupled to the vertical support via other suitable structure(s). Furthermore, in certain embodiments, the actuator may be directly coupled to the disc blade support, or the actuator may be coupled to the disc blade support via other suitable structure(s).

In certain embodiments, the disc blade angle adjustment assembly 12 may only include one of the actuator 62 or the pin 58. For example, in certain embodiments, the disc blade angle adjustment assembly 12 may control the angle of the disc blade support 34 with the actuator 62. In such embodiments, a cover may be disposed over the second pin apertures 60 to block insertion of the pin 58 through the second pin apertures 60. For example, the cover may be coupled to the horizontal base plate 40 with one or more fasteners. However, in the event that the actuator 62 does not function or does not function properly, the cover may be removed, and the pin 58 may be used to control the angle of the disc blade support 34, as discussed above. Furthermore, in certain embodiments, the actuator may be omitted, and the pin 58 may be used to control the angle of the disc blade support 34 (e.g., to reduce the cost of the disc blade angle adjustment assembly). As previously discussed, the horizontal protrusion 56 includes both the first pin aperture for the pin 58 and the fastener aperture 66 for the fastener 64 of the actuator 62. Accordingly, the disc blade angle adjustment assembly may be readily reconfigured for use with the actuator 62 or the pin 58. In addition, in certain embodiments including the actuator, the second pin apertures and the first pin aperture may be omitted. In such embodiments, the horizontal base plate may be omitted, and another suitable base structure may be coupled to the frame and to the vertical guide plate. Furthermore, in certain embodiments, the horizontal protrusion may be omitted. In such embodiments including the actuator, the actuator may be coupled to the vertical support or to the disc blade support, and in such embodiments including the pin, the first pin aperture may be formed within the vertical support.

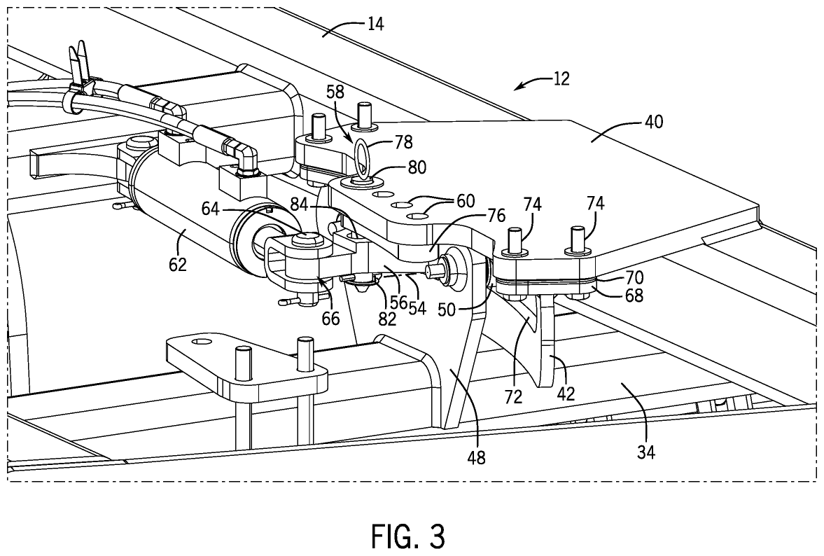

FIG. 3 is another perspective view of the disc blade angle adjustment assembly 12 of FIG. 2. In the illustrated embodiment, the disc blade adjustment assembly 12 includes a horizontal attachment plate 68 coupled to the vertical guide plate 42 and configured to couple the vertical guide plate 42 to the horizontal base plate 40. In the illustrated embodiment, the horizontal attachment plate 68 is coupled to the vertical guide plate 42 by a welded connection. However, in other embodiments, the horizontal attachment plate may be coupled to the vertical guide plate by other suitable type(s) of connection(s) (e.g., alone or in combination with the welded connection), such as a fastener connection, an adhesive connection, a clamped connection, other suitable type(s) of connection(s), or a combination thereof. Furthermore, in certain embodiments, the horizontal attachment plate may be integrally formed with the vertical guide plate.

In the illustrated embodiment, the disc blade angle adjustment assembly 12 includes shims 70 disposed between the horizontal attachment plate 68 and the horizontal base plate 40. The shims 70 are configured to adjust a vertical position (e.g., position along the vertical axis) of the elongated opening 72 relative to the frame (e.g., to level the disc blade support 34 relative to the frame). While the disc blade adjustment assembly 12 includes shims 70 in the illustrated embodiment, in other embodiments, the shims may be omitted. In the illustrated embodiment, the horizontal attachment plate 68 is coupled to the horizontal base plate 40 by a fastener connection, including fasteners 74 (e.g., bolts, pins, etc.). However, in other embodiments, the horizontal attachment plate may be coupled to the horizontal base plate by other suitable type(s) of connection(s) (e.g., alone or in combination with the fastener connection), such as a welded connection, an adhesive connection, a clamped connection, other suitable type(s) of connection(s), or a combination thereof. Furthermore, in certain embodiments, the horizontal attachment plate may be integrally formed with the horizontal base plate (e.g., in which the shims are omitted). In addition, in certain embodiments, the vertical guide plate may be directly coupled to the horizontal base plate, or the vertical guide plate may be coupled to the horizontal base plate by other suitable structure(s) (e.g., alone or in combination with the horizontal attachment plate).

In the illustrated embodiment, the disc blade angle adjustment assembly 12 includes a reinforcement plate 76 coupled to the horizontal base plate 40. The reinforcement plate includes pin apertures aligned with the second pin apertures 60 of the horizontal base plate 40. The reinforcement plate 76 is configured to increase the supported length of the pin and reduce an extent of a gap (e.g., between the reinforcement plate 76 and the horizontal protrusion 56) spanned by a body of the pin, thereby reducing the bending/shear stress on the pin. In the illustrated embodiment, the reinforcement plate 76 is coupled to the horizontal base plate 40 by a welded connection. However, in other embodiments, the reinforcement plate may be coupled to the horizontal base plate by other suitable type(s) of connection(s) (e.g., alone or in combination with the welded connection), such as a fastener connection, an adhesive connection, a clamped connection, other suitable type(s) of connection(s), or a combination thereof. Furthermore, in certain embodiments, the reinforcement plate may be integrally formed with the horizontal base plate. In addition, in certain embodiments, the reinforcement plate may be omitted.

In the illustrated embodiment, the pin 58 includes a handle 78, the body 80, and a locking element 82. The handle 78 is coupled to the body 80 and configured to facilitate removal of the pin from the first pin aperture 84 and the selected pin aperture of the second pin apertures 60. While the pin 58 includes a handle 78 in the illustrated embodiment, in other embodiments, the handle may be omitted. Furthermore, the locking element 82 is configured to selectively engage the body 80 to block removal of the pin 58 from the first pin aperture 84 and the selected second pin aperture 60. The locking element 82 may be disengaged to facilitate removal of the pin, and the locking element 82 may be engaged after the pin is disposed within the first and second pin apertures to block removal of the pin. The locking element 82 may include any suitable device/assembly configured to selectively engage the body to block removal of the pin, such as a clip, a click pin, a wire, another suitable device/assembly, or a combination thereof.

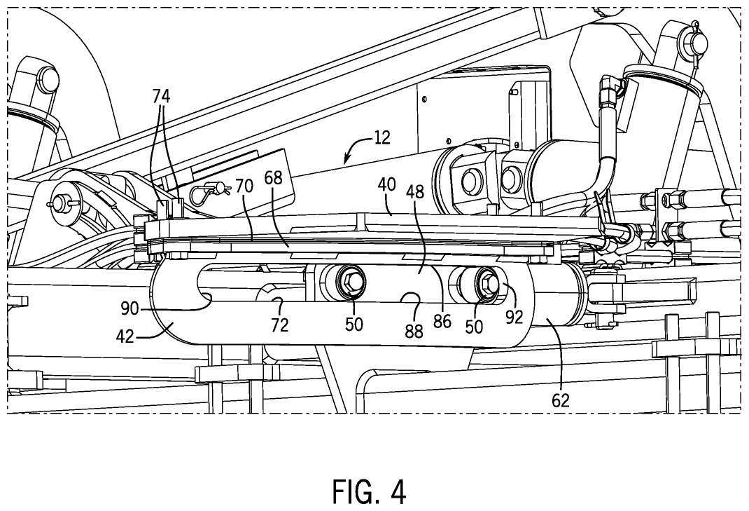

FIG. 4 is a further perspective view of the disc blade angle adjustment assembly 12 of FIG. 2. As previously discussed, the disc blade angle adjustment assembly 12 includes rollers 50 rotatably coupled to the vertical support 48 and disposed within the elongated opening 72 of the vertical guide plate 42. As illustrated, the elongated opening 72 is formed by an upper contact surface 86, a lower contact surface 88, a first end surface 90, and a second end surface 92 of the vertical guide plate 42. The rollers are configured to block rotation of the disc blade support about the longitudinal axis of the disc blade support via engagement (e.g., contact) with the vertical guide plate 42. For example, contact between one roller 50 and the upper contact surface 86 and contact between another roller 50 and the lower contact surface 88 blocks rotation of the disc blade support about the longitudinal axis of the disc blade support. In certain embodiments, the distance (e.g., along the vertical axis) between the upper contact surface 86 and the lower contact surface 88 may be slightly greater (e.g., 0.5 percent greater, 1 percent greater, 2 percent greater, etc.) than the diameter of the rollers 50, thereby facilitating rotation of the rollers 50 as the rollers 50 move through the elongated opening 72. Accordingly, the disc blade support may slightly rotate about the longitudinal axis of the disc blade support (e.g., 0.5 degrees, 1 degree, 2 degrees, etc.) in response to torque applied to the disc blade support about the longitudinal axis of the disc blade support. Furthermore, contact between both rollers 50 and the upper contact surface 86 blocks upward movement of the disc blade support, and contact between both rollers 50 and the lower contact surface 88 blocks downward movement of the disc blade support.

In addition, contact between one roller 50 and the first end surface 90 blocks rotation of the disc blade support about the pivot point/pivot axis in a first rotational direction, and contact between the other roller 50 and the second end surface 92 blocks rotation of the disc blade support about the pivot point/pivot axis in a second rotational direction. The distance between the end surfaces (e.g., circumferential extent of the elongated opening 72) may be selected to establish a desired range of motion of the disc blade support. While the vertical guide plate 42 includes two end surfaces in the illustrated embodiment, in other embodiments, at least one of the end surfaces may be omitted (e.g., both end surfaces may be omitted). Furthermore, while the vertical guide plate does not include any supports/extensions extending through the elongated opening 72 in the illustrated embodiment, in other embodiments, the vertical guide plate may include one or more supports/extensions extending (e.g., vertically extending) through the elongated opening. For example, in certain embodiments, a support/extension may extend through the elongated opening from the upper contact surface to the lower contact surface between the rollers to support the vertical guide plate and/or to block rotation of the disc blade support about the pivot point/pivot axis via contact with each roller.

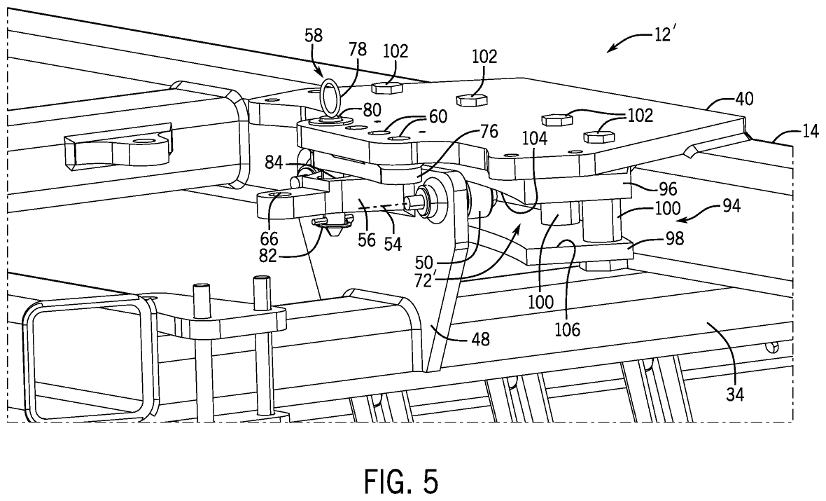

FIG. 5 is a perspective view of another embodiment of a disc blade angle adjustment assembly 12′ that may be employed within the tillage implement of FIG. 1. In the illustrated embodiment, the disc blade angle adjustment assembly 12′ includes a guide structure 94 coupled to the horizontal base plate 40 and having the elongated opening 72′. As previously discussed, the rollers 50 are disposed within the elongated opening 72′ of the guide structure 94, and the rollers 50 are configured to block rotation of the disc blade support 34 about the longitudinal axis of the disc blade support via engagement (e.g., contact) with the guide structure 94. In the illustrated embodiment, the guide structure 94 includes a top plate 96, a bottom plate 98, and spacers 100. The spacers 100 are disposed between (e.g., vertically between) the top plate 96 and the bottom plate 98, and the spacers 100 are configured to establish the elongated opening 72′ between the top plate 96 and the bottom plate 98. In the illustrated embodiment, the guide structure 94 has four spacers 100. However, in other embodiments, the guide structure may have more or fewer spacers (e.g., 1, 2, 3, 5, 6, or more).

In the illustrated embodiment, the top plate 96 is coupled to the horizontal base plate 40 by a welded connection. However, in other embodiments, the top plate may be coupled to the horizontal base plate by other suitable type(s) of connection(s) (e.g., alone or in combination with the welded connection), such as a fastener connection, an adhesive connection, a clamped connection, other suitable type(s) of connection(s), or a combination thereof. Furthermore, in certain embodiments, the top plate may be integrally formed with the horizontal base plate. In addition, in the illustrated embodiment, the top plate 96, the bottom plate 98, and the spacer(s) 100 are coupled to one another by a fastener connection. As illustrated, a respective fastener 102 (e.g., bolt, etc.) extends through each spacer 100, through the horizontal base plate 40, through the top plate 96, and through the bottom plate 98, thereby coupling the top plate 96, the bottom plate 98, and the spacer 100 to one another. In certain embodiments, the number of fasteners 102 may be equal to the number of spacers 100. While the top plate 96, the bottom plate 98, and the spacer(s) 100 are coupled to one another by a fastener connection in the illustrated embodiment, in other embodiments, the top plate, the bottom plate, and the spacer(s) may be coupled to one another by other suitable type(s) of connection(s) (e.g., alone or in combination with the fastener connection), such as a welded connection, an adhesive connection, a clamped connection, other suitable type(s) of connection(s), or a combination thereof Furthermore, in certain embodiments, the top plate, the bottom plate, and the spacer(s) may be integrally formed with one another. In addition, in certain embodiments, the spacer(s) may be coupled to the top plate by one suitable type of connection, and the spacer(s) may be coupled to the bottom plate by another suitable type of connection. Furthermore, in certain embodiments, the welded connection between the top plate and the horizontal base plate may be omitted, and the fastener(s) may couple the horizontal base plate, the top plate, the spacer(s), and the bottom plate to one another.

In the illustrated embodiment, the top plate 96 and the bottom plate 98 each have an arcuate shape with a radius of curvature extending from the pivot point/pivot axis. Accordingly, the elongated opening 72′ within the guide structure 94 extends along the circumferential axis. As a result, the rollers 50 may be aligned with the top and bottom plates along the radial axis at the elongated opening 72′ throughout the range of motion of the rollers 50 within the elongated opening. While the top and bottom plates have an arcuate shape in the illustrated embodiment, in other embodiments, at least one of the top plate or the bottom plate may have another suitable shape (e.g., linear, etc.). In such embodiments, the width (e.g., radial extent) of the top and bottom plates and/or the width (e.g., radial extent) of the rollers may be selected such that the rollers overlap the top and bottom plates along the radial axis at the elongated opening throughout the range of motion of the rollers within the elongated opening.

As illustrated, the elongated opening 72′ is formed by an upper contact surface 104 of the top plate 96 and a lower contact surface 106 of the bottom plate 98. The rollers 50 are configured to block rotation of the disc blade support 34 about the longitudinal axis of the disc blade support 34 via engagement (e.g., contact) with the top and bottom plates. For example, contact between one roller 50 and the upper contact surface 104 of the top plate 96 and contact between another roller 50 and the lower contact surface 106 of the bottom plate 98 blocks rotation of the disc blade support 34 about the longitudinal axis of the disc blade support 34. In certain embodiments, the distance (e.g., along the vertical axis) between the upper contact surface 104 and the lower contact surface 106 may be slightly greater (e.g., 0.5 percent greater, 1 percent greater, 2 percent greater, etc.) than the diameter of the rollers 50, thereby facilitating rotation of the rollers 50 as the rollers 50 move through the elongated opening 72′. Accordingly, the disc blade support 34 may slightly rotate about the longitudinal axis of the disc blade support (e.g., 0.5 degrees, 1 degree, 2 degrees, etc.) in response to torque applied to the disc blade support 34 about the longitudinal axis of the disc blade support 34. Furthermore, contact between both rollers 50 and the upper contact surface 104 blocks upward movement of the disc blade support 34, and contact between both rollers 50 and the lower contact surface 106 blocks downward movement of the disc blade support 34.

In the illustrated embodiment, the guide structure 94 does not include end surfaces configured to block rotation of the disc blade support about the pivot point/pivot axis. However, in other embodiments, the guide structure may include a first end surface configured to block rotation of the disc blade support about the pivot point/pivot axis in a first rotational direction in response to contact with one roller, and/or the guide structure may include a second end surface configured to block rotation of the disc blade support about the pivot point/pivot axis in a second rotational direction in response to contact with the other roller. Furthermore, while the guide structure does not include any supports/extensions extending through the elongated opening 72′ in the path of the rollers 50 in the illustrated embodiment, in other embodiments, the vertical guide plate may include one or more supports/extensions extending (e.g., vertically extending) through the elongated opening in the path of the rollers. For example, in certain embodiments, a support/extension may extend through the elongated opening from the upper contact surface to the lower contact surface between the rollers to block rotation of the disc blade support via contact with each roller.

All of the details and variations of the disc blade angle adjustment assembly 12 disclosed above with regard to FIGS. 2-4, except the details and variations related to the vertical guide plate 42, may apply to the disc blade angle adjustment assembly 12′ disclosed with regard to FIG. 5. Furthermore, while disc blade angle adjustment assemblies including the vertical guide plate 42 and the guide structure 94 are disclosed herein, in other embodiments, the disc blade angle adjustment assembly may include another suitable guide structure having the elongated opening. In addition, the tillage implement may include one or more disc blade angle adjustment assemblies 12 disclosed above with regard to FIGS. 2-4, one or more disc blade angle adjustment assemblies 12′ disclosed above with regard to FIG. 5, or a combination thereof. As used herein with regard to structures/elements/components of the disc blade angle adjustment assembly (e.g., including the vertical guide plate, the vertical support, the horizontal attachment plate, the horizontal protrusion, and the horizontal base plate), “vertical” and “horizontal” indicate that the structure/element/component extends generally along a vertical/horizontal direction/axis, but not necessarily entirely along the vertical/horizontal direction/axis. For example, the structure/element/component may be angled relative to the vertical/horizontal direction/axis (e.g., at an angle less than or equal to 45 degrees, at an angle less than 40 degrees, at an angle less than 35 degrees, at an angle less than 30 degrees, at an angle less than 25 degrees, at an angle less than 20 degrees, at an angle less than 15 degrees, at an angle less than 10 degrees, at an angle less than 5 degrees, at an angle less than 2 degrees, at an angle less than 1 degree, or at an angle less than 0.5 degrees).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A disc blade angle adjustment assembly for a tillage implement, comprising:
a base structure configured to couple to a frame of the tillage implement;
a vertical guide plate coupled to the base structure, wherein the vertical guide plate has an elongated opening;
a vertical support configured to couple to a disc blade support of the tillage implement, wherein the disc blade support is configured to pivotally couple to the frame at a pivot point, and the disc blade support is configured to support a plurality of disc blades; and
a plurality of rollers rotatably coupled to the vertical support and disposed within the elongated opening of the vertical guide plate, wherein the plurality of rollers is configured to block rotation of the disc blade support about a longitudinal axis of the disc blade support via engagement with the vertical guide plate.

2. The disc blade angle adjustment assembly of claim 1, wherein the vertical guide plate has an arcuate shape with a radius of curvature extending from the pivot point.

3. The disc blade angle adjustment assembly of claim 1, comprising:
a horizontal attachment plate coupled to the vertical guide plate and configured to couple the vertical guide plate to the base structure; and
a shim disposed between the horizontal attachment plate and the base structure, wherein the shim is configured to adjust a vertical position of the elongated opening relative to the frame.

4. The disc blade angle adjustment assembly of claim 1, wherein each roller of the plurality of rollers is only coupled to the vertical support.

5. The disc blade angle adjustment assembly of claim 1, comprising:
a horizontal protrusion coupled to the vertical support, wherein the horizontal protrusion has a first pin aperture, the base structure comprises a horizontal base plate, and the horizontal base plate has a plurality of second pin apertures; and
a pin configured to engage the first pin aperture and a selected pin aperture of the plurality of second pin apertures to block rotation of the disc blade support about the pivot point.

6. The disc blade angle adjustment assembly of claim 1, comprising an actuator coupled to the vertical support and configured to couple to the frame, wherein the actuator is configured to drive the disc blade support to rotate about the pivot point.

7. The disc blade angle adjustment assembly of claim 1, comprising:
a horizontal protrusion coupled to the vertical support, wherein the horizontal protrusion has a first pin aperture, the base structure comprises a horizontal base plate, the horizontal base plate has a plurality of second pin apertures, and the horizontal protrusion has a fastener aperture;
a pin configured to engage the first pin aperture and a selected pin aperture of the plurality of second pin apertures to block rotation of the disc blade support about the pivot point; and
an actuator having a fastener engaged with the fastener aperture of the horizontal protrusion, wherein the actuator is configured to couple to the frame, and the actuator is configured to drive the disc blade support to rotate about the pivot point.

8. A disc blade angle adjustment assembly for a tillage implement, comprising:
a horizontal base plate configured to couple to a frame of the tillage implement;
a guide structure coupled to the horizontal base plate, wherein the guide structure has an elongated opening;
a vertical support configured to couple to a disc blade support of the tillage implement, wherein the disc blade support is configured to pivotally couple to the frame at a pivot point, and the disc blade support is configured to support a plurality of disc blades;
a plurality of rollers rotatably coupled to the vertical support and disposed within the elongated opening of the guide structure, wherein the plurality of rollers is configured to block rotation of the disc blade support about a longitudinal axis of the disc blade support via engagement with the guide structure;
a horizontal protrusion coupled to the vertical support, wherein the horizontal protrusion has a first pin aperture, and the horizontal base plate has a plurality of second pin apertures; and
a pin configured to engage the first pin aperture and a selected pin aperture of the plurality of second pin apertures to block rotation of the disc blade support about the pivot point.

9. The disc blade angle adjustment assembly of claim 8, wherein the guide structure comprises:
a top plate;
a bottom plate; and
a spacer disposed between the top plate and the bottom plate, wherein the spacer is configured to establish the elongated opening between the top plate and the bottom plate.

10. The disc blade angle adjustment assembly of claim 9, comprising a fastener configured to extend through the horizontal base plate, the top plate, the bottom plate, and the spacer to couple the top plate, the bottom plate, and the spacer to one another.

11. The disc blade angle adjustment assembly of claim 9, wherein the top plate and the bottom plate each have an arcuate shape with a radius of curvature extending from the pivot point.

12. The disc blade angle adjustment assembly of claim 8, wherein each roller of the plurality of rollers is only coupled to the vertical support.

13. The disc blade angle adjustment assembly of claim 8, comprising an actuator having a fastener, wherein the horizontal protrusion has a fastener aperture, the fastener of the actuator is engaged with the fastener aperture of the horizontal protrusion, the actuator is configured to couple to the frame, and the actuator is configured to drive the disc blade support to rotate about the pivot point.

14. The disc blade angle adjustment assembly of claim 8, wherein the pin comprises a handle configured to facilitate removal of the pin from the first pin aperture and the selected pin aperture of the plurality of second pin apertures.

15. A disc blade angle adjustment assembly for a tillage implement, comprising:
a horizontal base plate configured to couple to a frame of the tillage implement;
a guide structure coupled to the horizontal base plate, wherein the guide structure has an elongated opening;
a vertical support configured to couple to a disc blade support of the tillage implement, wherein the disc blade support is configured to pivotally couple to the frame at a pivot point, and the disc blade support is configured to support a plurality of disc blades;
a plurality of rollers rotatably coupled to the vertical support and disposed within the elongated opening of the guide structure, wherein the plurality of rollers is configured to block rotation of the disc blade support about a longitudinal axis of the disc blade support via engagement with the guide structure;
a horizontal protrusion coupled to the vertical support, wherein the horizontal protrusion has a first pin aperture and a fastener aperture, the horizontal base plate has a plurality of second pin apertures, the first pin aperture and a selected pin aperture of the plurality of second pin apertures is configured to receive a pin to block rotation of the disc blade support about the pivot point, and the fastener aperture is configured to receive a fastener of an actuator configured to drive the disc blade support to rotate about the pivot point.

16. The disc blade angle adjustment assembly of claim 15, wherein the guide structure comprises a vertical guide plate.

17. The disc blade angle adjustment assembly of claim 16, wherein the vertical guide plate has an arcuate shape with a radius of curvature extending from the pivot point.

18. The disc blade angle adjustment assembly of claim 15, wherein the guide structure comprises:
a top plate;
a bottom plate; and
a spacer disposed between the top plate and the bottom plate, wherein the spacer is configured to establish the elongated opening between the top plate and the bottom plate.

19. The disc blade angle adjustment assembly of claim 18, wherein the top plate and the bottom plate each have an arcuate shape with a radius of curvature extending from the pivot point.

20. The disc blade angle adjustment assembly of claim 15, comprising the pin.
